(19) United States
(12) Patent Application Publication
(10) Pub. No.: US 2011/0304087 A1
(43) Pub. Date: Dec. 15, 2011

(54) LOG SPLITTER CRADLE

(76) Inventor: Van M. Gibson, Milwaukie, OR (US)

(21) Appl. No.: 13/155,992

(22) Filed: Jun. 8, 2011

Related U.S. Application Data
(60) Provisional application No. 61/354,192, filed on Jun. 12, 2010.

(51) Int. Cl. B27L 7/00

(52) U.S. Cl. 269/305

(57) ABSTRACT

A log splitter cradle assembly is described. The log splitter cradle assembly generally comprises a cradle base, a cradle base attachment assembly, and a pair of cradle sidewall assemblies. Simply stated, the log splitter cradle assembly of an embodiment may detachably engage a portable log splitter assembly to increase the safety and efficiency of the log splitter assembly. More specifically, the log splitter cradle assembly may removably couple to the log splitter base of the log splitter assembly to improve the guidance of a log prior to being split, during the split, and after the split.

### CROSS-REFERENCED TO RELATED APPLICATIONS

This application claims priority to, and benefit of, U.S. Provisional Application 61/354,192, filed Jun. 12, 2010, which is incorporated herein by reference.

### FIELD OF THE INVENTION

The present invention relates to a log cradle for a portable log splitter. More particularly, the present invention relates to a log cradle for a log splitter to position, stabilize, and retail logs in the work area until the desired size of split is achieved.

### BACKGROUND

A log splitter is a piece of equipment used for splitting firewood. A log splitter generally includes a hydraulic or electrical rod and piston assembly coupled to a blade that may exert approximately 20 tons to 34 tons of pressure on the log to split it with the blade. More specifically, the log splitter generally uses the hydraulic piston to either drive the log through a stationary blade or to drive the blade through a stationary log. The size and strength (i.e., pressure rating) of the log splitter may depend on residential and/or professional use and the size and/or type of logs to be split.

A log splitter, in particular a portable log splitter, may be powered by a gasoline, diesel, or electric engine. More specifically, the engine may drive a hydraulic pump to actuate the hydraulic piston to drive the log through the blade (or alternately to drive the blade through the log). The log splitter may often include wheels and/or a trailer assembly so that it may be towed and/or wheeled to a convenient location. The portability of certain log splitters allows them to be easily deployed to substantially replace the ax, maul, wedge, and other similar manual log splitting tools.

The efficiency and automation of the portable log splitter far outweighs the labor required to wield manual log splitting tools. Further, the hydraulic log splitter is far safer (albeit not 100% safe) than swinging heavy and/or sharply edged tools. Nevertheless, various portable log splitter design features may increase the utility, efficiency, and/or safety of the portable log splitter.

A number of devices have provided portable log splitters. The following represents a list of known related art:

| | | Date of |
|---|---|---|
| Reference: | Issued to: | Issue/Publication: |
| US 2009/0229709 | Babcock | Sep. 17, 2009 |
| U.S. Pat. No. 7,334,615 | Paradise | Feb. 26, 2008 |
| U.S. Pat. No. 6,698,479 | Kelso | Mar. 2, 2004 |
| U.S. Pat. No. 4,487,239 | Anderson | Dec. 11, 1984 |
| U.S. Pat. No. 4,461,331 | Mertz | Jul. 24, 1984 |
| U.S. Pat. No. 4,351,377 | Hamel | Sep. 28, 1982 |
| U.S. Pat. No. 4,239,070 | Burns | Dec. 16, 1980 |
| U.S. Pat. No. 4,141,396 | McCallister | Feb. 27, 1979 |
| U.S. Pat. No. 3,077,214 | Brunker | Feb. 12, 1963 |
| US D457,174 | Bissell | May 14, 2002 |

The teachings of each of the above-listed citations (which does not itself incorporate essential material by reference) are herein incorporated by reference. None of the above inventions and patents, taken either singularly or in combination, is seen to describe an embodiment or embodiments of the instant invention as claimed.

### SUMMARY AND ADVANTAGES

An embodiment is a log splitter cradle assembly, comprising a cradle base; a pair of cradle ramps coupled to the cradle base, the cradle ramps sloped inwardly toward the cradle base; and a cradle base attachment assembly to removably couple the cradle base to a log splitter. The log splitter cradle assembly may further comprise a pair of cradle interior sidewalls coupled to the cradle base and each of the pair of cradle ramps substantially along their medial edges. The log splitter cradle assembly may further comprise a pair of cradle exterior sidewalls coupled to the cradle base and each of the pair of cradle ramps substantially along their distal edges. The cradle interior sidewalls and the cradle exterior sidewalls may be substantially parallel. The cradle interior sidewalls and the cradle exterior sidewalls may have approximately uneven heights. The cradle interior sidewalls may have a lesser height than the cradle exterior sidewalls. The pair of cradle ramps may inwardly slope toward the cradle base at approximately between 7.8 and 8.2 degrees, and in an embodiment at approximately 8.0 degrees.

The log splitter cradle assembly of the present invention presents numerous advantages, including: (1) increases the efficiency of a log splitter; (2) increases the safety of the log splitter; (3) decreases the manual input required by the log splitter user to position and guide the log; (4) fits a variety of sizes and configurations of log splitters, for example 6.0 inch×6.0 inch or 6.0 inch×8.0 inch “I” or “H” beam framed log splitters; (5) operator can work from either side of the cradle; (6) adjusts forward or aft on the main I or H beam frame; (7) provides more than 3 square feet of working area once installed on the log splitter; (8) keeps the split log in the work area until the desired size of split is achieved; (9) allows the operator to remain in the standing upright position while splitting the rounds; and (10)

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows an end perspective view of the cradle assembly of an embodiment.

FIG. 2 shows a top perspective view of a log splitter assembly of an embodiment.

FIG. 3 shows a perspective view of the cradle assembly of an embodiment relative to the log splitter assembly.

FIG. 4 shows a perspective view of the cradle assembly of an embodiment coupled to the log splitter assembly

FIG. 5 shows a top view of the cradle assembly of an embodiment including the cradle ramps.

FIG. 6 shows an end view of the cradle assembly of an embodiment removably coupled to a log splitter base.

### REFERENCE NUMBERS USED IN DRAWINGS

Turning now descriptively to the drawings, in which similar reference characters denote similar elements throughout the several views, the figures illustrate the log splitter cradle assembly of an embodiment of the present invention. With regard to the reference numerals used, the following numbering is used throughout the various drawing figures:
10 log splitter cradle assembly
15 cradle base
20 cradle base attachment assembly
22 cradle base hold down bar
25 cradle base spacer bar
30 cradle base bolts
35 cradle sidewall assembly
40 cradle interior sidewall
45 cradle ramp
50 cradle exterior sidewall
55 cradle ramp lip protrusion
60 log splitter assembly
65 log splitter blade
70 log splitter end
75 log splitter end handle
80 log splitter base

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

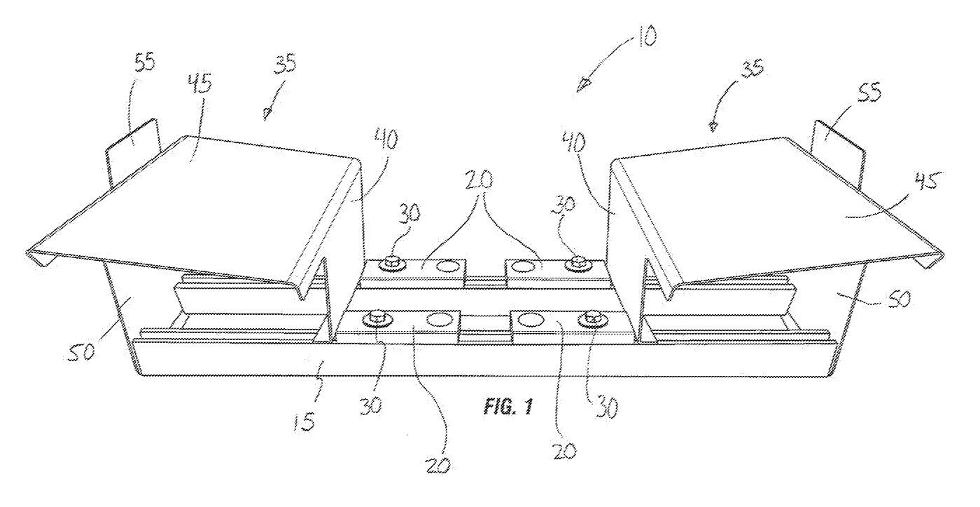

As shown in FIGS. 1-6, a log splitter cradle assembly 10 is provided. As shown in FIGS. 1-6, the log splitter cradle assembly 10 generally comprises a cradle base 15, a cradle base attachment assembly 20, and a pair of cradle sidewall assemblies 35. Simply stated, the log splitter cradle assembly 10 of an embodiment may detachably engage a portable log splitter assembly 60 to increase the safety and efficiency of the log splitter assembly 60. More specifically, the log splitter cradle assembly 10 may removably couple to the log splitter base 80 of the log splitter assembly 60 to improve the guidance of a log (not illustrated) prior to being split, during the split, and after the split.

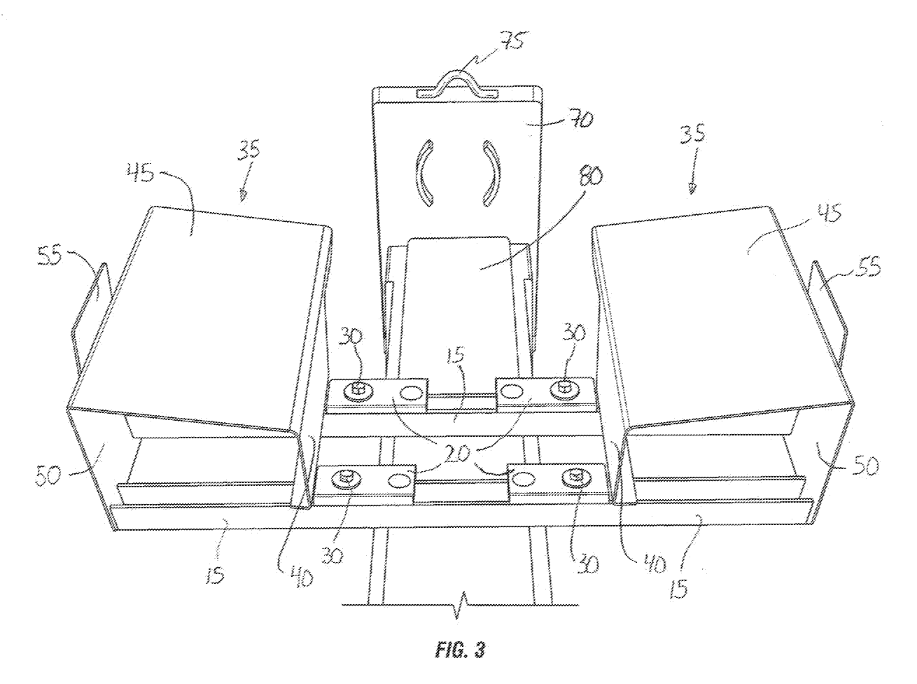

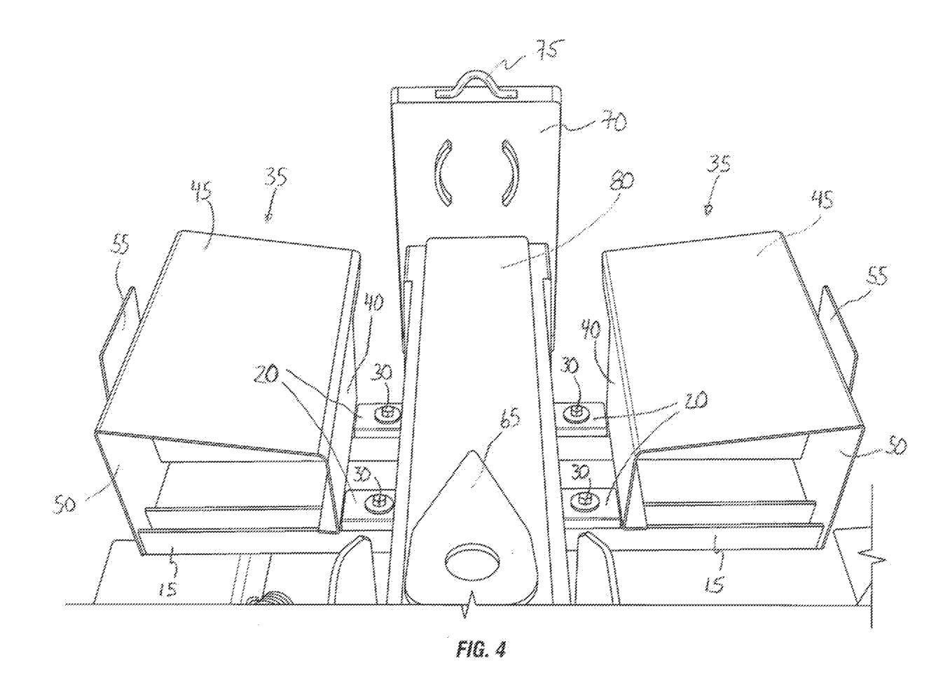

FIG. 1 shows an end perspective view of the log splitter cradle assembly 10 of an embodiment. The log splitter cradle assembly 10 of an embodiment may include a cradle base 15 formed as two substantially parallel beams. Each cradle base 15 beam may also have one or more cradle base attachment assemblies 20 coupled thereto. For example, each cradle base 15 beam may include two cradle base attachment assemblies 20 substantially centered on the approximate midpoint of the cradle base 15 with one cradle base attachment assembly 20 per side of the midpoint. As will be explained with reference to FIGS. 3 and 4, the cradle base attachment assemblies 20 may detachably couple to at least a portion of the log splitter base 80 thereby coupling the log splitter cradle assembly 10 to a log splitter assembly 60.

FIG. 1 further illustrates a pair of cradle sidewall assemblies 35 of an embodiment. As noted, the cradle sidewall assemblies 35 may improve the guidance and control of the log during all aspects of its processing (e.g., prior to being split, during the split, and after being split) to both increase the efficiency of the log splitter assembly 60 by requiring less manual guidance and/or interaction and likewise increasing the safety for at least the same reasons.

Each cradle sidewall assembly 35 of an embodiment may include a cradle interior sidewall 40 coupled to the one or more cradle base 15 beams adjacent the one or more cradle base attachment assemblies 20 on a given side (e.g., left or right of the midpoint) of the one or more cradle bases 15. The cradle interior sidewall 40 may extend approximately perpendicularly from the one or more cradle bases 15. Said differently, the cradle interior sidewall 40 may extend substantially vertically from the one or more cradle bases 15. In an embodiment, the cradle interior sidewall extends approximately between 5.5 and 8.0 inches from the one or more cradle bases 15 and has a width of approximately 9.0 inches.

Each cradle sidewall assembly 35 may further include a cradle exterior sidewall 50 coupled to the one or more cradle base 15 beams adjacent the distal ends of the one or more cradle base 15 beams. The cradle exterior sidewall 50 may extend approximately perpendicularly from the one or more cradle bases 15. Said differently, the cradle exterior sidewall 50 may extend substantially vertically from the one or more cradle bases 15. In an embodiment, the cradle exterior sidewall extends approximately between 6.5 and 9.0 inches from the one or more cradle bases 15 and has a width of approximately 9.0 inches.

In an embodiment, for each cradle sidewall assembly 35, the cradle interior sidewall 40 and the cradle exterior sidewall 50 couple to a cradle ramp 45 opposite the one or more cradle bases 15. As the cradle exterior sidewall 50 of an embodiment extends further from the one or more cradle bases 15 (i.e., has a greater height) than the cradle interior sidewall 40, the cradle ramp 45 slopes inward toward the midpoint of the log splitter cradle assembly 10. In an embodiment, the angle of the cradle ramp 45 slope may be approximately between 7.8 degrees and 8.2 degrees, and preferably approximately 8.0 degrees. Accordingly, the cross-sectional area defined by the cradle interior sidewall 40, the cradle ramp 45, the cradle exterior sidewall 50, and the cradle base 15 may approximate a trapezoid with the cradle interior sidewall 40 and the cradle exterior sidewall 50 having uneven lengths while being substantially parallel.

The slopes of the opposing cradle ramps 45 substantially guide any logs (split or otherwise) resting on either cradle ramp 45 toward the middle of the log splitter cradle assembly, for example toward the log splitter base 80 where they may be aligned with the log splitter blade 65 and the log splitter end 70. Each cradle ramp 45 may further include a cradle ramp lip protrusion 55 extending substantially vertically from the respective cradle exterior sidewall 50 past the surface of the cradle ramp 45 to substantially prevent a log from rolling or otherwise moving past the end of the cradle ramp 45. In an embodiment, each cradle ramp lip protrusion 55 may extend from the surface of the cradle ramp 45 by approximately 1.75 inches.

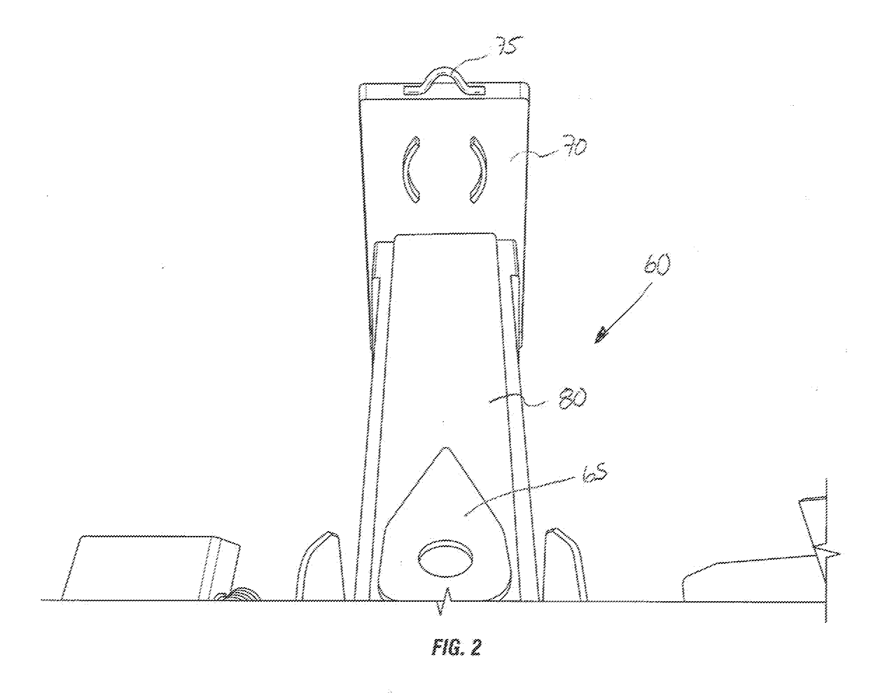

FIG. 2 shows a top perspective view of a log splitter assembly 60 of an embodiment. The log splitter assembly 60 may be a portable log splitter assembly 60 coupled to a trailer assembly (not illustrated). The log splitter assembly 60 may include a log splitter base 80, a log splitter end 70 including a log splitter end handle 75, and a log splitter blade 65. In an embodiment, the log splitter blade 65 may be coupled to a hydraulic piston (not illustrated) actuated by a gas, diesel, or electric hydraulic pump. The log splitter blade 65 may accordingly translate substantially linearly along the longitudinal axis of the log splitter base 80 to impact a log positioned and/or provided between the log splitter blade 65 and the log splitter end 70.

FIGS. 3 and 4 show a perspective view of the log splitter cradle assembly 10 of an embodiment relative to and removably coupled to the log splitter assembly 60 respectively. More specifically, the one or more cradle base 15 beams may extend beneath the log splitter base 80. In an embodiment, the cradle base 15 beams may include square tubing, for example 1.25 inches or 1.50 inches square with an approximate 0.12 inch wall thickness. The cradle base attachment assemblies 20 may removably couple to the log splitter base 80 to substantially removably couple the log splitter cradle assembly 10 to the log splitter assembly 60. The cradle base attachment assemblies 20 may removably couple to the log splitter base 80 with any mechanical attachment means, for example with one or more cradle base bolts 30. Further, at least the cradle base attachment assemblies 20 may be adjustable so that the log splitter cradle assembly 10 may substantially universally removably couple to any variety, size, and/or configuration of log splitter assembly 60. More specifically, the log splitter cradle assembly 10 may substantially universally removably couple to any variety of 6.0 inch×6.0 inch or 6.0 inch×8.0 inch “I” or “H” beam framed log splitter base 80.

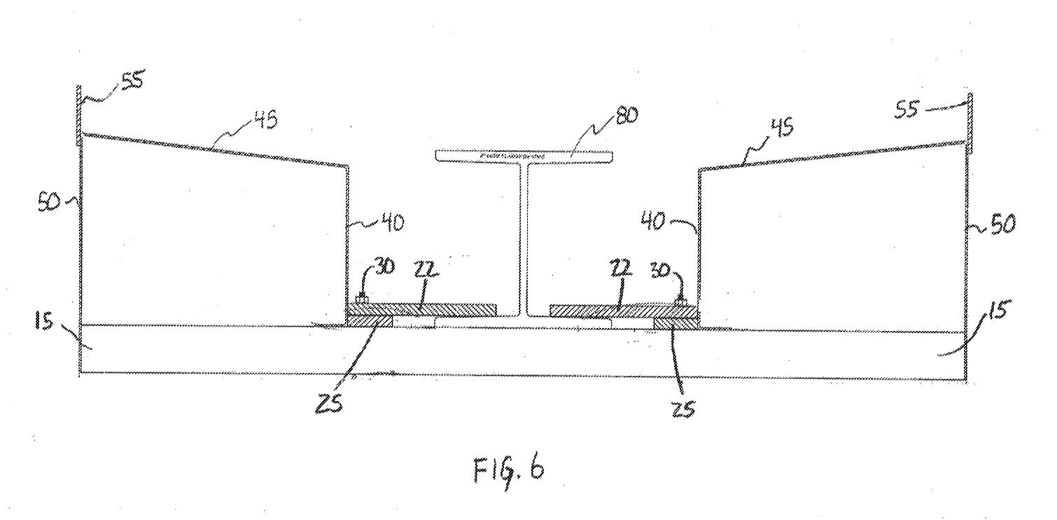

FIG. 6 shows an end view of the log splitter cradle assembly 10 of an embodiment removably coupled to a log splitter base 80. In an embodiment, the log splitter base may be an “I” beam or an “H” beam as introduced above. Each cradle base attachment assembly 20 may include a cradle base spacer bar 25 attached thereto at approximately a specified distance from the center of the cradle base 15. For example, the cradle base spacer bars 25 may be welded and/or otherwise substantially permanently attached to the cradle base 15 at approximately a specified distance from the center of the cradle base 15. Each cradle base attachment assembly 20 may further include a cradle base hold down bar 22 adjacent each cradle base spacer bar 25. In an embodiment, the cradle base hold down bars 22 are not attached to the cradle base spacer bars 25. In an embodiment, a cradle base spacer bar 25 may have approximate dimensions of 1.5 inches×2.75 inches×0.375 inches thick and a cradle base hold down bar 22 may have approximate dimensions of 2.0 inches×5.0 inches×0.375 inches thick.

The cradle hold down bars 22, cradle base spacer bars 25, and the cradle base 15 may include one or more apertures, holes, or slots formed and aligned therein into which cradle base bolts 30 may insert and tighten to couple the cradle base 15 to the log splitter base 80. For example, in an embodiment, at least the cradle base 15 and cradle base spacer bars 25 attached thereto may include slots so that the cradle base hold down bars 22 may be adjustable to accommodate various widths of the log splitter base 80. The position of the cradle base spacer bars 25 along the cradle base 15 may further determine the width of log splitter base 80 with which the log splitter cradle assembly 10 may be compatible. The thickness of the cradle base spacer bars 25 (in an embodiment approximately 0.375 inches) may further correspond to the thickness of the log splitter base 80 portion with which the cradle base attachment assembly 20 may detachably engage so that the engagement is substantially secure.

More specifically, to removably couple the log splitter cradle assembly 10 to a log splitter assembly 60, the cradle base bolts 30 (or other similar mechanical attachment means) may be loosened and removed so that the cradle base hold down bars 22 may be similarly removed. The log splitter cradle assembly 10 may be positioned under the log splitter assembly 60 so that the one or more cradle base 15 bars may contact the underside of the log splitter base 80. In an embodiment, the log splitter base 80 may be approximately centered on the one or more cradle base 15 bars by being approximately centered between the pair of cradle base spacer bars 25 attached to each one of the cradle base 15 bars. Thereafter, the cradle base hold down bars 22 may be positioned on top of both the cradle base spacer bars 25 and the log splitter base 80 so that the one or more apertures, holes, and/or slots in the cradle base hold down bars 22, cradle base spacer bars 25, and the cradle base 15 bars may substantially align. Cradle base bolts 30 and/or other mechanical attachment means may then be inserted in at least a portion of the one or more apertures, holes, and/or slots and tightened (in an embodiment, by attaching a nut or other tightening means—not illustrated), thereby detachably engaging the log splitter base 80 between the one or more cradle base 15 bars and the cradle base hold down bars 22. In an alternate embodiment, the cradle base 15 and/or the cradle base spacer bars 25 may include a bolt stud protruding there from (not illustrated) over which the cradle base hold down bars 22 may be placed and removably secured (e.g., by attaching a nut or other tightening means).

When the log splitter cradle assembly 10 is removably coupled to the log splitter assembly 60, the surface of the cradle ramp 45 adjacent the cradle interior sidewall 40 may be approximately level with the top of the log splitter base 80. Alternately, the surface of the cradle ramp 45 adjacent the cradle interior sidewall 40 may higher than or lower than the top of the log splitter base 80. In an embodiment, the surface of the cradle ramp 45 adjacent the cradle interior sidewall 40 may be approximately between 0.5 inch higher than to 0.5 inch lower than the top of the log splitter base 80. The slope of the cradle ramps 45 and the height difference between the cradle ramps 45 and the log splitter base 80 (if any) may guide a log in preparation for, during, and after being split by the log splitter blade 65. The guidance and/or control accordingly provided by the log splitter cradle assembly 10 of an embodiment may improve the efficiency and safety of the log splitting performed by the log splitter assembly 60. Alternately or additionally, the guidance and/or control provided by the log splitter cradle assembly 10 of an embodiment may decrease the manual input necessary by a user to guide the log.

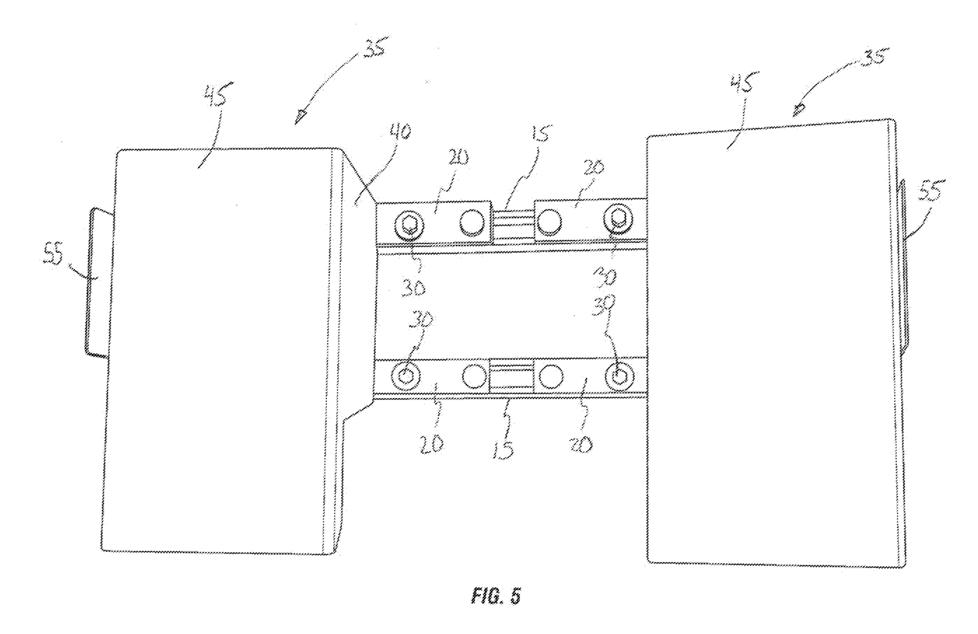

FIG. 5 shows a top view of the log splitter cradle assembly 10 of an embodiment including the cradle ramps 45. In an embodiment, each cradle ramp 45 may be substantially rectangular. Further, an edge of the cradle ramp 45 may extend beyond the one or more cradle base 15 beams. In an embodiment, the portion of each cradle ramp 45 that extends beyond the one or more cradle base 15 beams may extend toward the log splitter end 70.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A log splitter cradle assembly, comprising:
a cradle base;
a pair of cradle ramps coupled to the cradle base, the cradle ramps sloped inwardly toward the cradle base; and
a cradle base attachment assembly configured to removably couple the cradle base to a log splitter.

2. The log splitter cradle assembly of claim 1, further comprising a pair of cradle interior sidewalls coupled to the cradle base, the pair of cradle interior sidewalls coupled respectively to the pair of cradle ramps substantially along medial edges of the cradle ramps.

3. The log splitter cradle assembly of claim 2, further comprising a pair of cradle exterior sidewalls coupled to the cradle base, the pair of cradle exterior sidewalls coupled respectively to the pair of cradle ramps substantially along distal edges of the cradle ramps.

4. The log splitter cradle assembly of claim 3, wherein the cradle interior sidewalls and the cradle exterior sidewalls are substantially parallel.

5. The log splitter cradle assembly of claim 4 wherein the cradle interior sidewalls and the cradle exterior sidewalls have uneven heights.

6. The log splitter cradle assembly of claim 4 wherein the cradle interior sidewalls have a lesser height than the cradle exterior sidewalls.

7. The log splitter cradle assembly of claim 1, wherein the pair of cradle ramps slope inwardly toward the cradle base at approximately between 7.8 and 8.2 degrees.

8. The log splitter cradle assembly of claim 7, wherein the pair of cradle ramps slope inwardly toward the cradle base at approximately 8.0 degrees.

9. The log splitter cradle assembly of claim 1, the cradle base attachment assembly further comprising one or more spacer bars coupled to the cradle base.

10. The log splitter cradle assembly of claim 9, the cradle base attachment assembly further comprising one or more hold down bars, each hold down bar associated with one of the spacer bars, the one or more hold down bars removable from the one or more spacer bars.

11. The log splitter cradle assembly of claim 10, the cradle base attachment assembly further comprising one or more bolts to removably engage the one or more hold down bars to the one or more spacer bars and to the cradle base.

12. The log splitter cradle assembly of claim 11, the one or more hold down bars configured to clamp to the log splitter and configured to detachably engage the log splitter cradle assembly to the log splitter.
